(19) United States
(12) Patent Application Publication
(10) Pub. No.: US 2025/0388835 A1
(43) Pub. Date: Dec. 25, 2025

(54) CONCENTRATED CONTROLLED FOAM DETERGENT

(71) Applicant: ECOLAB USA INC., Saint Paul, MN (US)

(72) Inventors: Amanda R. Blattner, Prior Lake, MN (US); Seth Louis Marquard, High Point, NC (US)

(21) Appl. No.: 19/244,064

(22) Filed: Jun. 20, 2025

Related U.S. Application Data
(60) Provisional application No. 63/661,961, filed on Jun. 20, 2024.

(51) Int. Cl. C11D 1/83; A47L 15/00; A47L 15/44; C11D 1/14; C11D 1/22; C11D 1/66; C11D 1/72; C11D 1/722; C11D 1/75

(52) U.S. Cl. CPC C11D 1/8305; A47L 15/0086; A47L 15/4418; C11D 1/143; C11D 1/22; C11D 1/662; C11D 1/72; C11D 1/722; C11D 1/75

(57) ABSTRACT

Concentrated controlled foaming detergent compositions for cleaning are provided. Concentrated liquid compositions including at least 40% active surfactants in the liquid composition made up of an amine oxide surfactant, an anionic sulfonate surfactant, and an alkoxylated nonionic surfactant in a concentrate that has less than about 1 ppm 1,4-dioxane are provided. Methods of using the concentrated foam-controlled compositions for dishwashing are also provided.

### CROSS-REFERENCE TO RELATED APPLICATION

This application claims priority under 35 U.S.C. § 119 to Provisional Application U.S. Ser. No. 63/661,961, filed on Jun. 20, 2024, which is herein incorporated by reference in its entirety including without limitation, the specification, claims, and abstract, as well as any figures, tables, or examples thereof.

### TECHNICAL FIELD

The disclosure relates generally to concentrated controlled foaming detergent compositions for cleaning. Concentrated liquid compositions include at least 40% active surfactants in the liquid composition made up of an amine oxide surfactant, an anionic sulfonate surfactant, and an alkoxylated nonionic surfactant while providing a concentrate that has less than about 1 ppm 1,4-dioxane. Methods of using the concentrated foam-controlled compositions for dishwashing are also provided.

### BACKGROUND

Liquid detergent compositions are widely used to clean surfaces and warewash within dishwashers and sinks. Concentrating these liquid detergent compositions to provide efficacious cleaning while maintaining controlled foam is a challenge as highly concentrating surfactant concentrations within a composition can compromise ability to remain 1,4-dioxane compliant, maintain desired viscosity and foaming.

Thus, there exists a need in the art for concentrated liquid compositions having desired surfactant concentrations that do not exceed 1 ppm of 1,4-dioxane, do not introduce excessive foaming, have tunable viscosity to achieve dispensing targets, and provide desired foaming and surfactant performance.

It is therefore an object of this disclosure to provide concentrated liquid compositions that achieve these specifications.

It is a further object of the disclosure to provide methods of using concentrated foam-controlled dishwashing compositions.

Other objects, embodiments and advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art in providing highly concentrated detergent compositions.

According to some aspects of the present disclosure, concentrated liquid compositions comprise: at least about 40% active surfactants in the composition comprising: an amine oxide surfactant, an anionic sulfonate surfactant, and an alkoxylated nonionic surfactant, wherein the actives basis ratio of the anionic sulfonate surfactant(s) to the amine oxide surfactant is between about 7:1 to about 10:1; and wherein the concentrated liquid composition has less than about 1 ppm 1,4-dioxane.

According to some additional aspects of the present disclosure, methods of using a concentrated foam-controlled dishwashing composition comprise: contacting a ware surface within a recirculating sink or other containment with a use solution of the compositions as described herein; and cleaning the ware.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows the impact of a 5:1 AOS (Alpha olefin sulfonate): AO (amine oxide) actives basis ratio on total cylinder foam on four different detergents.

FIG. 2 shows the impact of the AOS:AO actives basis ratio on viscosity with four different detergents.

FIG. 3 shows the impact of the nonionic surfactant in the detergent tested on both the viscosity and total cylinder foam.

FIG. 4 shows the regression curve of % increase in total cylinder foam with % of nonionic surfactant present.

FIG. 5 shows that as the % of MgSO₄ in the solution is increased, the viscosity of the solution decreases.

FIG. 6 shows that as the amount of % salts (NaCl and Na₂SO₄) are increased in the solution, the level of viscosity increases.

FIG. 7 shows when the pH is altered and the % of salt is added to the solution, the viscosity of the solution varies.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented as exemplary illustrations of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It has been surprisingly found that concentrated liquid compositions containing at least 40% active surfactants including amine oxide, anionic sulfonate surfactant(s) and alkoxylated nonionic surfactant(s) are low 1,4-dioxane and do not introduce excessive foaming and/or have viscosity that would require specialized dispensing systems, while maintaining desired foaming and surfactant performance.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range.

All publications, including all patents, patent applications and other patent and non-patent publications cited or mentioned herein are incorporated herein by reference for at least the purposes that they are cited; including for example, for the disclosure or descriptions of methods of materials which may be used. Nothing herein is to be construed as an admission that a publication or other reference (including any reference cited in the Background section) is prior art to the invention or that the invention is not entitled to antedate such disclosure, for example, by virtue of prior invention.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, foam height, molecular weight, percentage actives, temperature, pH, humidity, molar ratios, log count of bacteria or viruses, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

As used herein, the term “between” is inclusive of any endpoints noted relative to a described range.

As used herein, the term “cleaning” refers to a method used to facilitate or aid in soil removal, bleaching, microbial population reduction, and any combination thereof.

Terms characterizing sequential order, a position, and/or an orientation are not limiting and are only referenced according to the views presented.

As used herein, the term “exemplary” refers to an example, an instance, or an illustration, and does not indicate a most preferred embodiment unless otherwise stated.

The phrase “free of” or similar phrases if used herein means that the composition comprises 0% of the stated component and refers to a composition where the component has not been intentionally added. However, it will be appreciated that such components may incidentally form thereafter, under some circumstances, or such component may be incidentally present, e.g., as an incidental contaminant.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “soil” or “stain” refers to any soil, including, but not limited to, non-polar oily and/or hydrophobic substances which may or may not contain particulate matter such as industrial soils, mineral clays, sand, natural mineral matter, carbon black, graphite, kaolin, environmental dust, and/or food based soils such as blood, proteinaceous soils, starchy soils, fatty soils, cellulosic soils, etc.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

As used herein, the term “substantially free” refers to compositions completely lacking the component or having such a small amount of the component that the component does not affect the performance of the composition. The component may be present as an impurity or as a contaminant and shall be less than 0.5 wt-%.

The term “surfactant” or “surface active agent” refers to an organic chemical that when added to a liquid decreases the surface tension or interfacial tension between two liquids, a liquid and a gas, or a liquid and a solid.

As used herein the terms “use solution,” “ready to use,” or variations thereof refer to a composition that is diluted, for example, with water, to form a use composition having the desired components of active ingredients for cleaning. For reasons of economics, a concentrate can be marketed, and an end-user can dilute the concentrate with water or an aqueous diluent to a use solution.

As used herein, the term “ware” refers to items such as eating and cooking utensils, dishes, and other hard surfaces such as showers, sinks, toilets, bathtubs, countertops, windows, mirrors, transportation vehicles, and floors. As used herein, the term “warewashing” refers to washing, cleaning, or rinsing ware. Ware also refers to items made of plastic. Types of plastics that can be cleaned with the compositions include but are not limited to, those that include polypropylene polymers (PP), polycarbonate polymers (PC), melamine formaldehyde resins or melamine resin (melamine), acrylonitrile-butadiene-styrene polymers (ABS), and polysulfone polymers (PS). Other exemplary plastics that can be cleaned using the compounds and compositions of the disclosure include polyethylene terephthalate (PET) polystyrene polyamide.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Compositions

According to embodiments, the concentrated liquid compositions include at least about 40% actives surfactants, or from about 40% to about 50% actives surfactants in the composition that are made up of an amine oxide surfactant, anionic sulfonate surfactant(s), and alkoxylated nonionic surfactant(s) and wherein the concentrated liquid composition has less than about 1 ppm 1,4-dioxane. The concentrated liquid compositions can include additional functional ingredients. Exemplary concentrated liquid compositions are shown in Table 1 in weight percentages of the components therein.

While the components may have a percent actives of 100%, it is noted that Tables 1A and 1B do not recite the percent actives of the components, but rather, recites the total weight percentage of the raw materials (i.e. active concentration plus inert ingredients, such as water). The entire weight percentage (100%) of the concentrated liquid compositions has at least about 40% actives surfactants.

TABLE 1A

| | First | Second | Third |
|---|---|---|---|
| | Exemplary | Exemplary | Exemplary |
| Material | Range wt.-% | Range wt.-% | Range wt.-% |
| Amine oxide | 1-20 | 5-20 | 5-15 |
| Anionic sulfonate | 20-80 | 25-80 | 30-80 |
| surfactant(s) | | | |
| Alkoxylated | 1-20 | 5-20 | 5-15 |
| nonionic | | | |
| surfactant | | | |
| Water | 5-50 | 5-40 | 10-40 |
| Additional | 0-30 | 1-30 | 1-25 |
| Functional | | | |
| Ingredients | | | |
| Total | 100 | 100 | 100 |

TABLE 1B

| | First | Second | Third |
|---|---|---|---|
| | Exemplary | Exemplary | Exemplary |
| Material | Range wt.-% | Range wt.-% | Range wt.-% |
| Amine oxide | 1-20 | 5-20 | 5-15 |
| Alpha Olefin | 15-60 | 20-60 | 25-50 |
| Sulfonate | | | |
| Additional | 1-20 | 5-20 | 5-15 |
| anionic | | | |
| sulfonate | | | |
| surfactant(s) | | | |
| Alkoxylated | 1-20 | 5-20 | 5-15 |
| nonionic | | | |
| surfactant | | | |
| Water | 5-50 | 5-40 | 10-40 |
| Additional | 0-30 | 1-30 | 1-25 |
| Functional | | | |
| Ingredients | | | |
| Total | 100 | 100 | 100 |

### Amine Oxide Surfactants

The concentrated liquid compositions comprises one or more amine oxide surfactants. Amine oxides can include alkyl amine oxides. Tertiary amine oxide surfactants typically comprise three alkyl groups attached to an amine oxide (N→O). Commonly the alkyl groups comprise two lower (C₁₋₄) alkyl groups combined with one higher (C₆₋₂₄) alkyl groups or can comprise two higher alkyl groups combined with one lower alkyl group. Further, the lower alkyl groups can comprise alkyl groups substituted with hydrophilic moiety such as hydroxyl, amine groups, carboxylic groups, etc.

In embodiments the alkyl amine oxide surfactants can include alkyl di(C₁-C₇) amine oxides in which the alkyl group has about 10-20 carbon atoms, or preferably 12-16 carbon atoms, and can be straight or branched chain, saturated or unsaturated. In preferred embodiments the amine oxide surfactant is a C10-C20 straight or branched chain, saturated or unsaturated alkyl di(C1-C7) amine oxide.

These amine oxides are tertiary amine oxides and have the general formula:

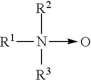

wherein R¹ is an alkyl radical from C10-C20, and R² and R³ are alkyl or hydroxyalkyl of C1-C7, or preferably from C1-C3, or a mixture thereof.

An exemplary structure of alkyl amine oxides are shown in the following structure:

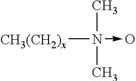

Further examples of alkyl amine oxides include lauryl dimethyl amine oxide, myristyl dimethyl amine oxide, and those in which the alkyl group is a mixture of different amine oxide, dimethyl cocoamine oxide, dimethyl (hydrogenated tallow) amine oxide, and myristyl/palmityl dimethyl amine oxide; alkyl di(hydroxy C₁-C₇) amine oxides in which the alkyl group has about 8-20 carbon atoms, and preferably 12-16 carbon atoms, and can be straight or branched chain, saturated or unsaturated. Examples of such compounds include bis(2-hydroxyethyl) cocoamine oxide, bis(2-hydroxyethyl) tallowamine oxide; and bis(2-hydroxyethyl) stearylamine oxide; alkylamidopropyl di(C1-C7) amine oxides in which the alkyl group has about 8-20 carbon atoms, and preferably 12-16 carbon atoms, and can be straight or branched chain, saturated or unsaturated. Examples of such compounds include cocoamidopropyl dimethyl amine oxide and tallowamidopropyl dimethyl amine oxide; and alkylmorpholine oxides in which the alkyl group has about 10-20 carbon atoms, and preferably 12-16 carbon atoms, and can be straight or branched chain, saturated or unsaturated. Particularly preferred are alkyl amine oxides in which the alkyl group has about 10-14 carbon atoms, and preferably has 12 carbon atoms, which are preferably saturated. Especially preferred is lauryl dimethyl amine oxide.

In further preferred embodiments the amine oxide surfactant is a lauryl dimethyl amine oxide, dimethyl cocoamine oxide, dimethyl (hydrogenated tallow) amine oxide, and myristyl/palmityl dimethyl amine oxide.

Alkyl amine oxides are commercially available from various vendors and examples include Ammonyx LO, a Lauryl Dimethyl Amine Oxide, and Barlox 12, a Lauryl Dimethyl Amine Oxide.

In some embodiments, the amine oxide surfactant(s) is included in the concentrated liquid compositions at an amount of at least about 1 wt-% to about 20 wt-%, about 5 wt-% to about 20 wt-%, or about 5 wt-% to about 15 wt-%. In addition, without being limited according to the disclosure, all ranges recited are inclusive of the numbers defining the range and include each integer within the defined range.

### Anionic Sulfonate Surfactants

The concentrated liquid compositions comprises one or more anionic sulfonate surfactants. The anionic sulfonate surfactants can include alkyl sulfonates and aromatic sulfonates with or without substituents, sulfonated carboxylic acid esters, or combinations thereof. In an embodiment the anionic sulfonate surfactant is an alpha olefin sulfonate, alkane sulfonate, alkyl sulfonate, sulfonated carboxylic acid ester, or combination thereof.

In an embodiment, an anionic sulfonate surfactant is an alkyl sulfonate, including linear and branched primary and secondary alkyl sulfonates, and the aromatic sulfonates with or without substituents. In a preferred embodiment the anionic sulfonate surfactant is an alpha olefin sulfonate or its salts. Alpha olefin sulfonates are available as aqueous solutions, powders or as a solid anhydrous product. Preferred anionic sulfonates include C8-C22 alpha olefin sulfonates, or C8-C16 alpha olefin sulfonates. Beneficially, alpha olefin sulfonate surfactants are stable in hard water.

In an embodiment, an anionic surfactant is sulfonates, such as a sulfonated carboxylic acid ester. In an aspect, suitable alkyl sulfonate surfactants include C8-C22 alkyl sulfonates, or preferably C8-C16 alkyl sulfonates or C10-C22 alkyl sulfonates. In an exemplary aspect, the anionic alkyl sulfonate surfactant is linear alkyl benzene sulfonic acid (LAS).

In a preferred embodiment the anionic sulfonate surfactant is an alpha-olefin sulfonate (AOS). In a further preferred embodiment the anionic sulfonate surfactant is a linear alkyl benzene sulfonate surfactant (LAS). The combination of an alpha-olefin sulfonate (AOS) and a linear alkyl benzene sulfonate surfactant (LAS) is a further preferred embodiment of the concentrated liquid compositions.

In some embodiments, the anionic sulfonate surfactant(s) is included in the concentrated liquid compositions at an amount of at least about 20 wt-% to about 80 wt-%, about 25 wt-% to about 80 wt-%, or about 30 wt-% to about 80 wt-%. In addition, without being limited according to the disclosure, all ranges recited are inclusive of the numbers defining the range and include each integer within the defined range.

In some embodiments, the anionic sulfonate surfactant(s) include an alpha-olefin sulfonate (AOS) in the concentrated liquid compositions at an amount of at least about 15 wt-% to about 60 wt-%, about 20 wt-% to about 60 wt-%, or about 25 wt-% to about 50 wt-%. In addition, without being limited according to the disclosure, all ranges recited are inclusive of the numbers defining the range and include each integer within the defined range.

In some embodiments, the anionic sulfonate surfactant(s) include an alpha-olefin sulfonate (AOS) in the concentrated liquid compositions at an amount of at least about 20 wt-% to about 60 wt-%, about 30 wt-% to about 60 wt-%, or about 30 wt-% to about 50 wt-%, in combination with an additional anionic sulfonate surfactant, such as for example a linear alkyl benzene sulfonate surfactant (LAS) in the concentrated liquid compositions at an amount of at least about 1 wt-% to about 20 wt-%, about 5 wt-% to about 20 wt-%, or about 5 wt-% to about 15 wt-%. In addition, without being limited according to the disclosure, all ranges recited are inclusive of the numbers defining the range and include each integer within the defined range.

In embodiments the anionic sulfonate surfactant(s) is included in the concentrated liquid compositions at an actives basis ratio with the amine oxide surfactant from about 4:1 to about 10:1, or preferably from about 7:1 to about 10:1.

In further embodiments the anionic sulfonate surfactant alpha-olefin sulfonate (AOS) is included in the concentrated liquid compositions at an actives basis ratio with the amine oxide surfactant from about 3:1 to about 5:1, or preferably from about 4:1 to about 5:1.

In these embodiments, beneficially the actives ratio provides desired foaming and viscosity of the composition. In an embodiment, the ratio provides a concentrate composition viscosity between about 500 cPs to about 1000 cPs when measured with a Brookfield RV Viscometer at 25° C. with Spindle #2 or #3 at 50 rpm. In an embodiment, the ratio further provides a measured cylinder foam between about 200 to about 250 as measured by the Cylinder Foam Test described in the Examples.

### Alkoxylated Nonionic Surfactants

The concentrated liquid compositions comprises one or more alkoxylated nonionic surfactants. Alkoxylated nonionic surfactants include EO/PO copolymers, capped EO/PO copolymers, alcohol alkoxylates, capped alcohol alkoxylates, and combinations thereof. In an embodiment the compositions include at least one low foaming and one high foaming alkoxylated nonionic surfactants to provide foam-controlled compositions.

In embodiments the low foaming alkoxylated nonionic surfactant comprises a polyoxypropylene-polyoxyethylene block copolymer surfactant. Exemplary polyoxypropylene-polyoxyethylene block copolymer surfactant have the general structure R—O—(PO)y(EO)x(PO)z where R is an alkyl group, x=9-22, y=1-4 and z=10-20. One commercially available example includes Plurafac SLF-180.

Another exemplary low foaming alkoxylated nonionic surfactant comprises a polyoxypropylene-polyoxyethylene block copolymer surfactant having the structure R—O-(EO)x(PO)y(EO)x where R is an alkyl group, x=10-130 and y=15-70. In some embodiments of the structure x plus y is in the range of about 25 to about 200. However, it should be understood that each x and y in a molecule can be different. The nonionic block copolymer surfactants can be characterized as heteric polyoxyethylene-polyoxypropylene block copolymers and are commercially available as SURFONIC®, PLURONIC® and TOMADOL, TETRONIC® surfactants, commercially available from BASF such as Surfonic LF-18 a C10 (2-Propylheptyl) Alcohol, Alkoxylate.

In embodiments the high foaming alkoxylated nonionic surfactant comprises an alcohol alkoxylate surfactant. Alcohol alkoxylates can include linear or branched structures according to the following formula R—O—(CH₂CH₂O)n-H wherein R is a (C1-C12) alkyl group, and n is an integer in the range of 1 to 100. In some embodiments. R may be a (C₅-C₁₂) alkyl group, or may be a (C₅-C₁₀) alkyl group. Similarly, in some embodiments, n is an integer in the range of 10-50, or in the range of 15-30, or in the range of 20-25

In embodiments the alkoxylated nonionic surfactant is a C6-C10 alkoxylated nonionic surfactant, including those having the structure 2 ethylhexyl (PO)m(EO)n structure. In a preferred embodiment the alcohol alkoxylate surfactant is commercially available as Plurafac SLF-180 which is a C10 (2-Propylheptyl) Alcohol, Alkoxylate or a Surfonic L12-6 alcohol alkoxylate. Additional commercially available alcohol alkoxylates include for example, linear alcohol ethoxylates such as Surfonic L12-3 a C10-12 linear primary alcohol, 3EO, Tomadol 91-2.5 a C10-12 Linear Alcohol, 3 EO or C9-11 Linear Alcohol, 2.5 EO.

Suitable alkoxylated surfactants include EO/PO block copolymers, such as the Pluronic and reverse Pluronic surfactants; alcohol alkoxylates, such as Dehypon LS-54 (R-(EO)₅(PO)₄) and Dehypon LS-36 (R-(EO)₃(PO)₆); and capped alcohol alkoxylates, such as Plurafac LF221 and Tegoten EC11; mixtures thereof, or the like.

In some embodiments, the alkoxylated nonionic surfactant(s) is included in the concentrated liquid compositions at an amount of at least about 1 wt-% to about 20 wt-%, about 5 wt-% to about 20 wt-%, or about 5 wt-% to about 15 wt-%. In addition, without being limited according to the disclosure, all ranges recited are inclusive of the numbers defining the range and include each integer within the defined range.

### Additional Functional Ingredients

The components of the concentrated liquid compositions can further be combined with various functional components suitable for uses disclosed herein, including warewashing detergents. In some embodiments, the concentrated liquid compositions including the amine oxide surfactant, anionic sulfonate surfactant(s), alkoxylated nonionic surfactant(s) and water make up a large amount, or even substantially all of the total weight of the compositions. For example, in some embodiments few or no additional functional ingredients are disposed therein.

In other embodiments, additional functional ingredients may be included in the concentrated liquid compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the concentrated liquid compositions may include additional surfactants, defoaming agents (also referred to as foam inhibitors), pH-adjusting compound, carrier or solvents, coupler, preservatives, anti-redeposition agents, optical brighteners, bleaching agents, rheology and/or solubility modifiers or thickeners (including those evaluated herein), hydrotropes or couplers, buffers, additional cleaning agents dispersants, metal protecting agents, stabilizing agents, corrosion inhibitors, chelating agents, enzymes, aesthetic enhancing agents including fragrances and/or dyes, and the like.

In some embodiments the concentrated liquid compositions are substantially free of or free of salts, gums, polysaccharides, clays and/or polymers.

In some embodiments the concentrated liquid compositions are substantially free of or free of sodium lauryl ether sulfate (SLES).

In some embodiments, the concentrated liquid compositions may include additional anionic and/or nonionic surfactants, defoaming agents, pH-adjusting compounds, carrier or solvents, coupler, preservatives, rheology and/or solubility modifiers or thickeners, hydrotropes or couplers, buffers, additional cleaning agents, chelating agents, aesthetic enhancing agents including fragrances and/or dyes, and the like.

In embodiments additional surfactants that can be formulated into the concentrated liquid compositions include those disclosed in US2013/0139856, which is hereby incorporated by reference in its entirety.

In embodiments the concentrated liquid compositions can include an additional anionic surfactants. Exemplary additional anionic surfactants include for example: alcohol ether carboxylates, sulfates, carboxylates, ethoxy carboxylates, and phosphate esters.

Anionic sulfate surfactants include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C5-C17 acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like. Also included are the alkyl sulfates, alkyl poly (ethyleneoxy) ether sulfates and aromatic poly (ethyleneoxy) sulfates such as the sulfates or condensation products of ethylene oxide and nonyl phenol (usually having 1 to 6 oxyethylene groups per molecule).

Additional anionic surfactants include anionic carboxylate surfactants, those which have a carboxylic acid or an alpha hydroxyl acid group. Anionic carboxylate surfactants suitable for use in the compositions also include carboxylic acids (and salts), such as alkanoic acids (and alkanoates), ester carboxylic acids (including sulfonated carboxylic acid esters), ether carboxylic acids, sulfonated fatty acids, such as sulfonated oleic acid, and the like. In an aspect, suitable ester carboxylic acids include alkyl succinates, such as for example dioctyl sulfosuccinate. Such carboxylates include alkyl ethoxy carboxylates, alkyl aryl ethoxy carboxylates, alkyl polyethoxy polycarboxylate surfactants and soaps (e.g. alkyl carboxyls).

Secondary carboxylates include those which contain a carboxyl unit connected to a secondary carbon. The secondary carbon can be in a ring structure, e.g. as in p-octyl benzoic acid, or as in alkyl-substituted cyclohexyl carboxylates. The secondary carboxylate surfactants typically contain no ether linkages, no ester linkages and no hydroxyl groups. Further, they typically lack nitrogen atoms in the head-group (amphiphilic portion). Suitable secondary surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g. N-acyl sarcosinates), taurates (e.g. N-acyl taurates and fatty acid amides of methyl tauride), and the like.

In embodiments the concentrated liquid compositions can include an alkyl polyglycosides. Suitable alkyl polyglycosides include but are not limited to alkyl polyglucosides Alkyl polyglycosides are bio-based nonionic surfactants which have wetting and detersive properties. Commercially available alkyl polyglycosides may contain a blend of carbon lengths. Suitable alkyl polyglycosides include alkyl polyglycosides containing short chain carbons, such as chain lengths of less than C₁₂. In one example, suitable alkyl polyglycosides include C₈-C₁₀ alkyl polyglycosides and alkyl polyglycosides blends primarily containing C₈-C₁₀ alkyl polyglycosides. Suitable commercially available alkyl polyglucosides include Glucopon 215 UP available from BASF Corporation.

In embodiments the concentrated liquid compositions can include a carrier. Exemplary carriers include for example, water, propylene glycol, glycerols, alcohols or mixtures thereof.

In embodiments the concentrated liquid compositions can include a preservative. Generally, preservatives fall into specific classes including phenolics, halogen compounds, quaternary ammonium compounds, metal derivatives, amines, alkanolamines, nitro derivatives, biguanides, analides, organosulfur and sulfur-nitrogen compounds, alkyl parabens, and miscellaneous compounds. Some non-limiting examples of phenolic preservative agents include pentachlorophenol, orthophenylphenol, chloroxylenol, p-chloro-m-cresol, p-chlorophenol, chlorothymol, m-cresol, o-cresol, p-cresol, isopropyl cresols, mixed cresols, phenoxyethanol, phenoxyethylparaben, phenoxyisopropanol, phenyl paraben, resorcinol, and derivatives thereof. Some non-limiting examples of halogen compounds include sodium trichloroisocyanurate, sodium dichloroisocyanurate, iodine-poly (vinylpyrolidin-onen) complexes, and bromine compounds such as 2-bromo-2-nitropropane-1,3-diol, and derivatives thereof. Some non-limiting examples of quaternary ammonium compounds include benzalkonium chloride, benzethonium chloride, behentrimonium chloride, cetrimonium chloride, and derivatives thereof. Some non-limiting examples of amines and nitro containing compounds include hexahydro-1,3,5-tris (2-hydroxyethyl)-s-triazine, dithiocarbamates such as sodium dimethyldithiocarbamate, and derivatives thereof. Some non-limiting examples of biguanides include polyaminopropyl biguanide and chlorhexidine gluconate. Some non-limiting examples of alkyl parabens include methyl, ethyl, propyl and butyl parabens.

In embodiments the concentrated liquid compositions can include a pH-adjusting compound that is a basic agent. Examples of basic pH-adjusting compounds include, but are not limited to, ammonia; mono-, di-, and trialkyl amines; mono-, di-, and trialkanolamines; alkali metal and alkaline earth metal hydroxides; alkali metal phosphates; alkali sulfates; alkali metal carbonates; and mixtures thereof. However, the identity of the basic pH adjuster is not limited, and any basic pH-adjusting compound known in the art can be used. Specific, nonlimiting examples of basic pH-adjusting compounds are ammonia; sodium, potassium, and lithium hydroxide; sodium and potassium phosphates, including hydrogen and dihydrogen phosphates; sodium and potassium carbonate and bicarbonate; sodium and potassium sulfate and bisulfate; monoethanolamine; trimethylamine; isopropanolamine; diethanolamine; and triethanolamine.

In embodiments the concentrated liquid compositions can include a pH-adjusting compound that is an acidic agent. The identity of an acidic pH-adjusting compound is not limited and any acidic pH-adjusting compound known in the art, alone or in combination, can be used. Examples of specific acidic pH-adjusting compounds are the mineral acids and polycarboxylic acids. Nonlimiting examples of mineral acids are hydrochloric acid, nitric acid, phosphoric acid, and sulfuric acid. Nonlimiting examples of polycarboxylic acids are citric acid, glycolic acid, and lactic acid.

In embodiments the concentrated liquid compositions can include additional foam inhibitors. Foam inhibitors may be optionally included for reducing the stability of any foam that is formed, especially when anionic surfactants are included in the formulation. Examples of foam inhibitors include silicon compounds such as silica dispersed in polydimethylsiloxane, fatty amides, hydrocarbon waxes, fatty acids, fatty esters, fatty alcohols, fatty acid soaps, ethoxylates, mineral oils, polyethylene glycol esters, polyoxyethylene-polyoxypropylene block copolymers, alkyl phosphate esters such as monostearyl phosphate and the like.

According to embodiments of the disclosure, the various additional functional ingredients may be provided in a composition in the amount from about 0 wt-% and about 40 wt-%, from about 0 wt-% and about 40 wt-%, from about 0.1 wt-% and about 30 wt-%, from about 1 wt-% and about 30 wt-%, from about 1 wt-% and about 25 wt-%, or from about 1 wt-% and about 20 wt-%. In addition, without being limited according to the disclosure, all ranges recited are inclusive of the numbers defining the range and include each integer within the defined range.

### Methods of Use

The concentrated liquid compositions are suited for washing ware and other hard surfaces and objects. The concentrated liquid compositions are efficacious as detergent compositions for washing ware and other hard surfaces and objects, including removing soils from such surfaces and objects, including for example fatty and proteinaceous soils, organic soils, and films/foams that are left as residues on surfaces and objects.

In a particular embodiment, the concentrated liquid compositions are efficacious for cleaning and dishwashing in a sink, namely a recirculating sink, or other containment. Various types of sinks can be utilized including traditional sinks and systems for pot and pan applications.

The concentrated liquid compositions are particularly suitable for use with open washing devices (also called power soaking devices or power sinks). Open washing devices are used to clean articles such as dishes, flatware, and cookware in commercial applications. Open washing devices are open-topped containers (i.e., a large sink-like device) with an agitator located in the device to continuously agitate and/or heat a detergent solution. The agitator could include jets. Because such devices are not closed like an automatic dishmachine, the cleaning operation is observable by the operator. Suitable detergent compositions for use in an open washing device must have adequate cleaning power without the necessity of the high-pressured jets typically used in an enclosed automatic dishwasher. The detergent must also foam enough that an operator knows there is detergent in the sink, but not so much that agitation produces excessive foam that spills over the top of the sink or into adjoining compartments. Exemplary open washing devices include the POWER SOAK® pot washing system from MetCraft Corporation (Grandview, Mo.) as well as other pot and pan washing systems such as those disclosed in U.S. Pat. No. 4,773,436. An exemplary MetCraft POWER SOAK® pot washing system includes the MetCraft MX-220-H POWER SOAK® Pot Washing System.

The concentrated liquid compositions can be used in the food service industry and in particular the fast food service industry. Fast food service companies desire a cleaning system which can be used throughout a given workday (i.e., 12 hours or more per day).

In some embodiments, a desired amount of the concentrated liquid compositions is added to an open washing system. The amount of the concentrated liquid compositions can range from about 0.04% to about 0.2% by volume of the diluent in the sink or containment.

During operation, the open washing system (e.g. power sink) is filled with water at a desired temperature, typically from about 40° C. (100° F.) to about 50° C. (120° F.) to an operating level as specified by the manufacturer's specified fill line or level within a washing system (e.g. typically about 8.9 cm (3.5 inches) from an upper edge of the sink). Then the water-agitation mechanism is started. Ware or other articles, including food preparation items like pots and pans or other articles are placed in the sink of the open washing system and soaked for a period of time of up to four hours. The articles are then removed, and rinsed and sanitized before use.

In some embodiments, the method includes soaking ware or other articles in an open washing system where the open washing system includes a use solution of the concentrated liquid compositions as described herein and as shown in Tables 1A-1B for example.

In embodiments one skilled in the art will appreciate that the viscosity of the concentrated liquid compositions is tunable to achieve dispensing targets. Preferably the viscosity of the compositions falls within a range that can be used with conventional dispensing systems. In an embodiment the concentrated liquid composition has a viscosity between about 500 cPs to about 1000 cPs, or preferably between about 700 cPs to about 850 cPs, when measured with a Brookfield RV Viscometer at 25° C. with Spindle #2 or #3 at 50 rpm. As a further benefit of the concentrated liquid compositions, the concentrated liquid composition achieves the liquid viscosity between about 500 cPs to about 1000 cPs, or preferably between about 700 cPs to about 850 cPs, without the use of (e.g. substantially free of or free of) salts, gums, polysaccharides, clays and/or polymers.

The viscosity of the concentrated liquid composition can be adjusted by increasing or decreasing the actives ratio of surfactants. In an embodiment the viscosity is increased by increasing the actives ratio of the anionic sulfonate alpha olefin sulfonate surfactant to the amine oxide surfactant up to about 5:1 to slow the dispensing rate, or in embodiments with anionic surfactants including a combination of anionic surfactants by increasing the anionic sulfonate surfactants (e.g. alpha olefin sulfonate and a linear alkyl benzene sulfonate) to the amine oxide surfactant up to about 10:1 to slow the dispensing rate.

The adjustment of viscosity to dispense a desired amount over a period of time (dispensing rate) is particularly beneficial to thicken the concentrated liquid compositions such that approximately half as much can be dispensed compared to an unconcentrated formula.

The concentrated liquid compositions beneficially provide the concentrated surfactants, at least about 40% actives surfactants in the composition, or between about 40-50% actives surfactants in the composition without exceeding 1 ppm of 1,4-dioxane. As a still further benefit, the concentrated liquid compositions do not introduce excessive foaming. In embodiments, the concentrated liquid composition has a measured cylinder foam between about 200 to about 250 as measured by a Cylinder Foam Test as a direct comparison to the unconcentrated liquid composition.

### EMBODIMENTS

The present disclosure is further defined by the following numbered embodiments:

1. A concentrated liquid composition comprising: at least about 40% active surfactants in the composition comprising: an amine oxide surfactant, an anionic sulfonate surfactant, and an alkoxylated nonionic surfactant, wherein the actives basis ratio of the anionic sulfonate surfactant to the amine oxide surfactant is about 7:1 to about 10:1; and wherein the concentrated liquid composition has less than about 1 ppm 1,4-dioxane.

2. The composition of paragraph 1, wherein the composition has between about 40-50% active surfactants in the composition.

3. The composition of any one of paragraphs 1-2, wherein the amine oxide surfactant is a C10-C20 straight or branched chain, saturated or unsaturated alkyl di(C1-C7) amine oxide, preferably a lauryl dimethyl amine oxide, dimethyl cocoamine oxide, dimethyl (hydrogenated tallow) amine oxide, and myristyl/palmityl dimethyl amine oxide.

4. The composition of any one of paragraphs 1-3, wherein the anionic sulfonate surfactant comprises an alpha-olefin sulfonate (AOS) and wherein the ratio of the AOS to amine oxide on an actives basis is from about 3:1 to about 5:1, or preferably from about 4:1 to about 5:1.

5. The composition of any one of paragraphs 1-4, wherein the anionic sulfonate surfactant comprises an alkyl benzene sulfonate surfactant (LAS), and optionally wherein the anionic sulfonate surfactant comprises an alkyl benzene sulfonate surfactant (LAS) and an alpha-olefin sulfonate (AOS) and wherein the ratio of the sulfonate surfactants to the amine oxide on an actives basis is from about 7:1 to about 10:1.

6. The composition of any one of paragraphs 1-5, wherein the alkoxylated nonionic surfactant comprises a polyoxypropylene-polyoxyethylene block copolymer surfactant having the structure R—O—(PO)y(EO)x(PO)z where R is an alkyl group, x=9-22, y=1-4 and z=10-20, or R—O-(EO)x(PO)y(EO)x where R is an alkyl group, x=10-130 and y=15-70.

7. The composition of any one of paragraphs 1-5, wherein the alkoxylated nonionic surfactant comprises an alcohol alkoxylate having the structure R—O—(CH₂CH₂O)n-H wherein R is a (C1-C12) alkyl group, and n=1-100, or an alcohols C6-C10, ethoxylated, propoxylated.

8. The composition of any one of paragraphs 1-7, wherein the anionic sulfonate surfactant comprises an alpha-olefin sulfonate (AOS) and alkyl benzene sulfonate surfactant (LAS).

9. The composition of any one of paragraphs 1-8, wherein the amine oxide surfactant comprises from about 5 wt-% to about 20 wt-% of the composition, the anionic sulfonate surfactant comprises from about 25 wt-% to about 80 wt-% of the composition, and the alkoxylated nonionic surfactant comprises from about 5 wt-% to about 20 wt-% of the composition.

10. The composition of paragraph 9, wherein the anionic sulfonate surfactant comprises from about 10 wt-% to about 60 wt-% of an alpha-olefin sulfonate (AOS) and from about 5 wt-% to about 20 wt-% of an alkyl benzene sulfonate surfactant (LAS).

11. The composition of any one of paragraphs 1-10, further comprising propylene glycol and/or an alkyl polyglycoside, preferably an alkyl polyglucoside.

12. The composition of any one of paragraphs 1-11, wherein the concentrated liquid composition has a viscosity between about 500 cPs to about 1000 cPs when measured with a Brookfield RV Viscometer at 25° C. with Spindle #2 or #3 at 50 rpm, and wherein the concentrated liquid composition achieves the liquid viscosity without the use of (e.g. substantially free of or free of) salts, gums, polysaccharides, clays and/or polymers.

13. The composition of any one of paragraphs 1-12, wherein the concentrated liquid composition has a measured cylinder foam between about 200 to about 250 as measured by a Cylinder Foam Test, or wherein the foam profile as measured in a cylinder foam test is substantially equivalent to a non-concentrated liquid composition.

14. The composition of any one of paragraphs 1-13, wherein the composition is free of sodium lauryl ether sulfate (SLES).

15. A method of using a concentrated foam-controlled dishwashing composition comprising: contacting a ware surface within a recirculating sink or other containment with a use solution of the composition according to any one of paragraphs 1-14; and cleaning the ware.

16. The method of paragraph 15, further comprising an initial step of dispensing the concentrated liquid composition.

17. The method of any one of paragraphs 15-16, wherein the viscosity of the concentrated liquid composition is increased by increasing the actives ratio of the anionic sulfonate surfactant to the amine oxide surfactant up to about 10:1 to slow the dispensing rate.

18. The method of any one of paragraphs 15-17, further comprising generating the use solution with the concentrated liquid composition by adding into the recirculating sink between about 0.04% to about 0.2% by weight of the concentrated liquid composition with the total volume of water in the recirculating sink.

19. The method of any one of paragraphs 15-18, wherein the recirculating sink is an open washing device (e.g. power sink), or wherein the other containment is a sink or vessel for washing ware.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

Evaluated concentrated liquid compositions were compared to a Commercial Control 1 having a lower percent active surfactants (<30%) and as summarized in Table 2.

TABLE 2

| Description | Quantity (wt.-%) |
|---|---|
| Water | 50-80 |
| Acrylic Polymer Thickener | <1 |
| Sodium Hydroxide (NaOH) 50% and | 1-10 |
| additional alkalinity sources. | |
| Ethoxylated Linear Alcohol C10-12 6 Moles | 1-20 |
| EO | |
| Alkoxylated Linear Alcohol | 1-10 |
| Dodecyl Benz Sulfonic Acid 96% | 1-20 |
| Sodium Lauryl Ether Sulfate 60% | 1-10 |
| Additional Functional ingredients | 1-10 |
| Total | 100 |

The concentrated liquid compositions tested included the following components: Glucopon 625 UP: Alkylpolyglucoside.

Ammonyx LO: Amine Oxide 1: Lauryl Dimethyl Amine Oxide 30%, commercially available from available from Stepan Co.

Barlox 12: Amine Oxide 2: Lauryl Dimethyl Amine Oxide 30%, commercially available from available from Lonza.

Linear Alkylbenzene Sulfonate (LAS), 96%, commercially available as various tradenames such as Bio-Soft S-101.

Surfonic L 12-6:12 Carbon 6 mole ethoxylate linear, primary C10-C12 alcohol.

Tomadol 91-6: An ethoxylated alcohol surfactant. C9-11 or C10-12 Linear Alcohol, 6 EO

Sodium Lauryl Ether Sulfate (SLES), 60% low dioxane, commercially available from various sources under tradenames such as Sterol CS-460 Plus.

Plurafac SLF-180: C10 (2-Propylheptyl) Alcohol, Alkoxylate.

Bio-Terge AS-40K Sodium alpha C14-16 Olefin Sulfonate (AOS).

### Example 1

A cylinder foam test for manual pot and pan detergents method was conducted in order to assess the total cylinder foam of four different variations of the concentrated liquid compositions with varying actives ratios of LAS+AOS:AO in order to assess the impact on viscosity.

The four different concentrated liquid compositions tested are shown in Table 3 and included 1) concentrated liquid composition with Amine Oxide 1, 2) concentrated liquid composition with Amine Oxide 2, 3) concentrated liquid composition with Amine Oxide 1 and Alkylpolyglucoside, and 4) concentrated liquid composition with Amine Oxide 2 and Alkylpolyglucoside. Each concentrated liquid composition combination tested still included SLES in the formulation.

Each of the four above compositions were tested utilizing the Cylinder Foam Testing Procedure.

TABLE 3

| | LAS + AOS:AO | LAS + AOS:AO | LAS + AOS:AO |
|---|---|---|---|
| Description | 4:1 | 7:1 | 10:1 |
| Soft Water | 20-30 | 20-30 | 20-30 |
| Linear Alkylbenzene | 10-30 | 10-30 | 10-30 |
| Sulfonate 96% | | | |
| Sodium Hydroxide | 1-10 | 1-10 | 1-10 |
| (NaOH) 50% | | | |
| Triethanol Amine 99% | <1 | <1 | <1 |
| L12-6 | 1-10 | 1-10 | 1-10 |
| Alkyl Polyglucoside | 0 | 0 | 0 |
| SLES 60% low- | 1-10 | 1-10 | 1-10 |
| dioxane | | | |
| SLF-180 | 5-20 | 5-20 | 5-20 |
| AOS 40% | 20-40 | 20-40 | 20-40 |
| Amine Oxide 1 or 2, | 5-30 | 5-30 | 5-25 |
| 30% | | | |
| Total | 100.00 | 100.00 | 100.00 |
| % Active Surfactants | 40-50 | 40-50 | 40-50 |
| PPM Dioxane | <1 | <1 | <1 |
| % AOS + LAS | 20-45% | 20-45% | 20-45% |
| % AO | 2-10% | 2-10% | 2-10% |

TABLE 4

| | LAS + AOS:AO | LAS + AOS:AO | LAS + AOS:AO |
|---|---|---|---|
| | 4:1 | 7:1 | 10:1 with |
| | with Alkylpoly | with Alkylpoly | Alkylpoly |
| Description | glucoside | glucoside | glucoside |
| Soft Water | 20-30 | 20-30 | 20-30 |
| Propylene Glycol | 0 | 0 | 0 |
| Sodium Xylene | 0 | 0 | 0 |
| Sulfonate 40% | | | |
| Linear Alkylbenzene | 10-20 | 10-20 | 10-20 |
| Sulfonate 96% | | | |
| Sodium Hydroxide | 1-5 | 1-5 | 1-5 |
| (NaOH) 50% | | | |
| Triethanol Amine 99% | <1 | <1 | <1 |
| Alkyl Polyglucoside | 10-15 | 10-15 | 10-15 |
| SLES 60% low- | 1-5 | 1-5 | 1-5 |
| dioxane | | | |
| SLF-180 | 5-15 | 5-15 | 5-15 |
| AOS 40% | 20-40 | 20-40 | 20-40 |
| Amine Oxide 1 or 2, | 5-20 | 5-20 | 5-20 |
| 30% | | | |
| Total | 100.00 | 100.00 | 100.00 |
| % Active Surfactants | 40-50 | 40-50 | 40-50 |
| PPM Dioxane | <1 | <1 | <1 |
| % AOS + LAS | 20-45% | 20-45% | 20-45% |
| % AO | 2-10% | %2-10 | 2-10% |

The concentrated liquid composition formulations in Tables 3 and 4 were also altered in a series of formulation testing to include different ranges of active surfactants, i.e. 40% actives to 50% actives, in order to create a higher concentration of active surfactants. Thus, the final formulations may be altered to create a higher concentration of active surfactants if desired. For the purposes of the testing described below, formulation was used, with an active level of 40-50% as shown in Tables 3 and 4.

The procedure used to test each liquid detergent composition was the Cylinder Foam Test for Manual Pot and Pan Detergent, outlined below.

Each liquid detergent composition was tested in the following examples was added by 40 mL to a 250 ml stoppered graduated cylinder, allowed to reach room temperature The cylinder was then rotated for 4 minutes by a motor driven rotation device at 30 rpm (rotations per minute). After four minutes the initial foam height was recorded in mL of foam.

The total foam height was recorded in mL of foam. The foam height was the total volume of liquid and foam. Two more drops of test soil were then added using a disposable pipette to the center of cylinder. The cylinder was then rotated at 30 rpm for another 2 minutes. The foam height was once again recorded before adding another 2 more drops of test soil using a disposable pipette.

This process was repeated until foam height reached a height of 45 mL or less. Each test was performed in quadruplicate and average foam height was used to judge performance.

The following formula was used to calculate the detergent's performance by a single number:

$$\begin{matrix}Total Foam \\ Height\end{matrix} = \sum ( \begin{matrix}Individual \\ Foam Heights\end{matrix} ) - ( \begin{matrix}Number of \\ Foam Heights\end{matrix} ) \cdot 40 mL$$

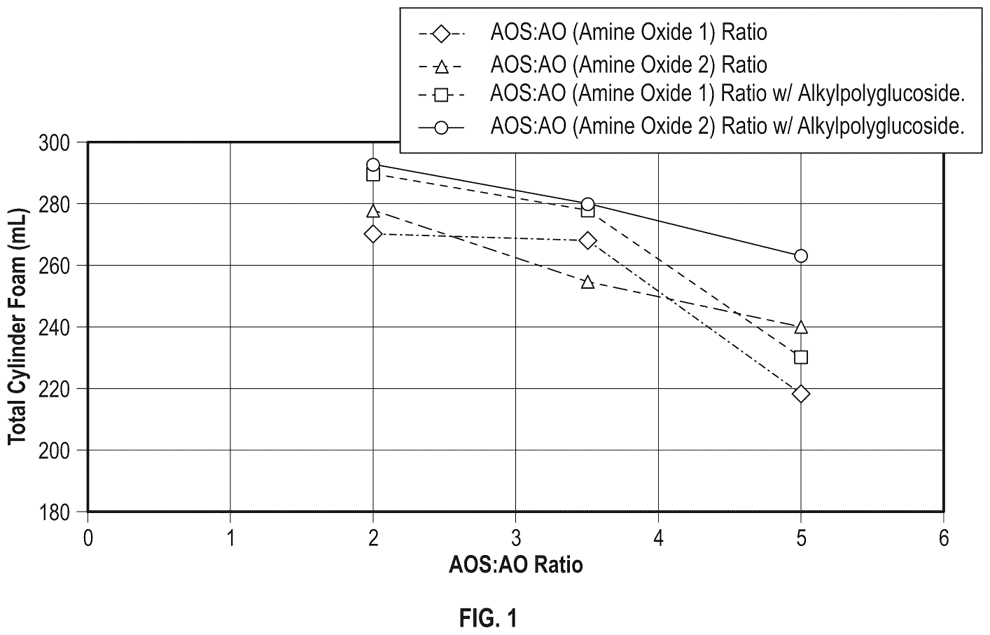

As the LAS+AOS:AO actives basis ratio increased from 4 to 10 as shown in FIG. 1, the total cylinder foam decreased. The results of the testing with the formulations are also shown in the Tables below.

The lowest total cylinder foam was achieved with a 10:1 LAS+AOS:AO actives ratio for each of the four variations of the Formulation. Thus, the 10:1 LAS+AOS:AO actives ratio was shown to be the most effective at achieving the lowest total cylinder foam across each detergent tested. These results were then used to assess the impact on viscosity of the detergent.

### Example 2

The data from Example 1 prompted further testing for whether the four variations of the concentrated liquid compositions were tested as shown in Tables 3 and 4 above: 1) concentrated liquid composition with Amine Oxide 1, 2) concentrated liquid composition with Amine Oxide 2, 3) concentrated liquid composition with Amine Oxide 1 and Alkylpolyglucoside, and 4) concentrated liquid composition with Amine Oxide 2 and Alkylpolyglucoside had an impact on viscosity of the concentrated liquid composition. Each formulation was run once again with SLES in each formulation.

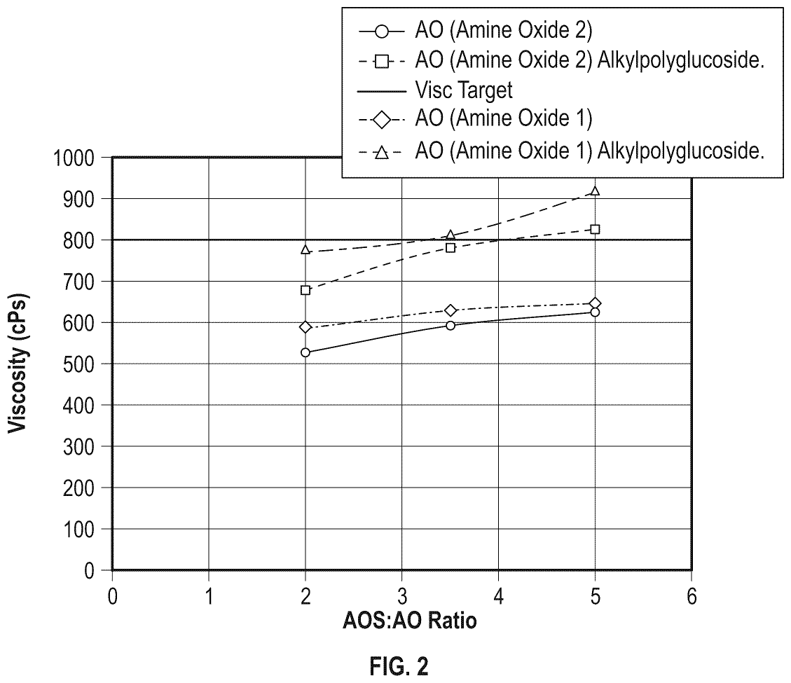

The target viscosity goal was set at 800 cps (centipoise). Each of the four above detergents tested in Example 1 were further evaluated for viscosity. Each of the four concentrated liquid compositions tested demonstrated that Alkylpolyglucoside added a boost in viscosity up to 800 cps. As shown in FIG. 2, the Formulation with Amine Oxide 2, and Formulation with Amine Oxide 1 with Alkylpolyglucoside, each had surpassed the viscosity minimum target of 800 as the LAS+AOS:AO actives ratio increased to 8:1 and 10:1.

Furthermore, as the LAS+AOS:AO actives ratio increased, so did the viscosity for each of the four detergents tested. The results further indicated that the 10:1 LAS+AOS:AO actives ratio were shown to be the most effective in achieving the target viscosity across two out of the four detergents tested.

### Example 3

The concentrated liquid composition with Amine Oxide 1 was tested again with 40-50% actives utilizing the same Cylinder Foam Testing Procedure outlined previously in Example 1 in order to evaluate how the viscosity and the total cylinder foam were impacted by the amount of SLF-180. This time, the concentrated liquid compositions with Amine Oxide 1 did not have SLES present in order to meet regulatory requirements surrounding Dioxane content. The modified concentrated liquid compositions are shown in Table 5.

TABLE 5

| Description | 10:1 | 10:1 | 10:1 | 10:1 | 10:1 |
|---|---|---|---|---|---|
| Soft Water | 25-30 | 25-30 | 25-30 | 25-30 | 25-30 |
| Linear | 10-15 | 10-15 | 10-15 | 10-15 | 10-15 |
| Alkylbenzene | | | | | |
| Sulfonate 96% | | | | | |
| Sodium Hydroxide | 1-5 | 1-5 | 1-5 | 1-5 | 1-5 |
| (NaOH) 50% | | | | | |
| Triethanol | <1 | <1 | <1 | <1 | <1 |
| Amine 99% | | | | | |
| L12-6 | 5-10 | 5-10 | 5-10 | 5-10 | 5-10 |
| Alkyl | 0 | 0 | 0 | 0 | 0 |
| Polyglucoside | | | | | |
| SLES 60% | 0 | 0 | 0 | 0 | 0 |
| low-dioxane | | | | | |
| SLF-180 | 5-10 | 5-10 | 5-10 | 5-10 | 5-10 |
| AOS 40% | 30-40 | 30-40 | 30-40 | 30-40 | 30-40 |
| Amine Oxide | 5-10 | 5-10 | 5-10 | 5-10 | 5-10 |
| 1 or 2, 30% | | | | | |
| Total | 100.00 | 100.00 | 100.00 | 100.00 | 100.00 |
| % Active | 40-50 | 40-50 | 40-50 | 40-50 | 40-50 |
| Surfactants | | | | | |
| PPM Dioxane | <1 | <1 | <1 | <1 | 0 |
| % LAS + AOS | 20-45% | 20-45% | 20-45% | 20-45% | 20-45% |
| % AO | 2-10% | 2-10% | 2-10% | 2-10% | 2-10% |

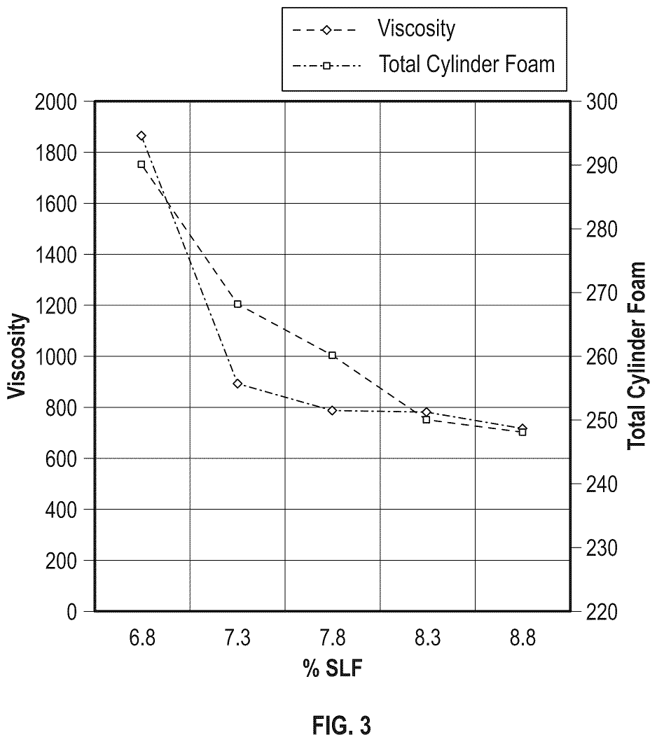

As shown in FIG. 3, once the % of non-ionic surfactant increased from 6.8 to 8.8, the viscosity shown and the total cylinder foam both decreased. This demonstrated that the amount of SLF-180 present can be changed to increase the foam or decrease the foam within the detergent.

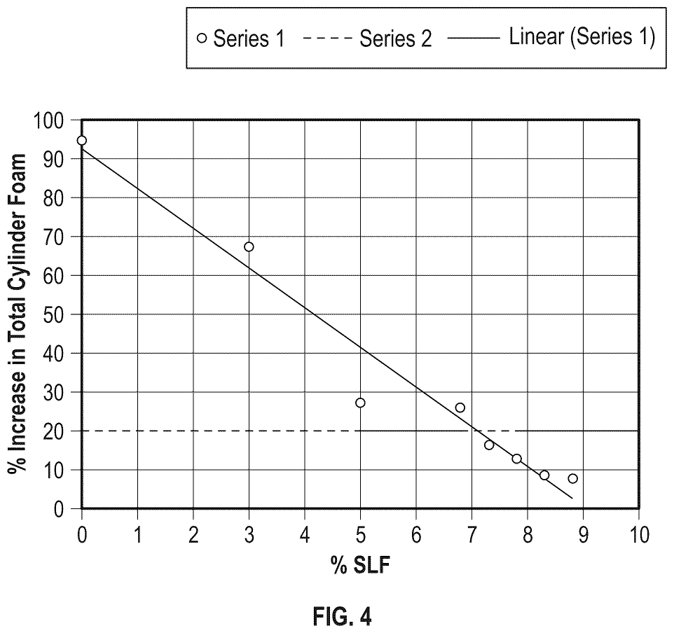

FIG. 4 demonstrated the same results as a regression curve demonstrating once again that the amount of SLF-180 impacts the total cylinder foam. Thus, the formula may be changed in order to increase or decrease the amount of foam according to the amount of SLF-180 present in the detergent.

Additionally, the data in FIG. 3 revealed that there was a balance between total cylinder foam and viscosity with a sharp increase in viscosity seen with less than 7% SLF-180 in the detergent tested. Thus, the results confirmed that the amount of SLF-180 present had a significant impact on the total cylinder foam as well as the viscosity.

### Example 4

The solution specified in Table 6 was tested in a series of ladder studies with different clarifying agents in order to assess which of these agents in combination with the formula produced one phase, clear and stable solutions. Additionally, these agents were assessed to evaluate which would result in the mosteconomical for a clear, stable and one phase formula.

TABLE 6

| Description | Quantity (wt.-%) |
|---|---|
| Soft Water | 15-20 |
| LAS 96% | 10-15 |
| Sodium Hydroxide | 1-5 |
| (NaOH) 50% and | |
| additional | |
| alkalinity sources. | |
| Triethanolamine | <1 |
| 99% | |
| L12-6 | 5-10 |
| Sodium Lauryl | 1-5 |
| Ether Sulfate 60% | |
| SLF-180 | 5-10 |
| AOS 40% | 30-35 |
| CAPB (Cocamidopropyl | 10-15 |
| Betaine) 30% | |
| Total | 100 |

A series of clarifying agents were tested with the solution of Table 6. These clarifying agents are as follows:
Sodium Xylene Sulfonate.
Propylene Glycol.
Hexylene glycol.
Sodium Octyl Sulfate.

The solution in Table 6 was tested by adding each clarifying agent individually into beakers in order to evaluate which of the couplers would yield a clear, stable and one phase solution at varying temperatures.

A series of beakers were filled with the solution of Table 6 each provided as a 500 gram sample before adding a clarifying agent. The amount of clarifying agents referenced in Tables 7-10 were added to each sample and balanced from water charge in each formula. Each clarifying agent was added to each individual beaker until the solution was clear and only one phase. Each beaker was then placed under a viscometer to be tested for the formula's viscosity at a speed of 50 rotations per minute. Additionally, each beaker was evaluated for the solution's appearance in order to assess whether the solution is clear, and in one phase.

Furthermore, each beaker was placed in a refrigerator at 40° F. overnight in order to evaluate the solution's stability.

Each beaker was also placed in an oven at 120° F. overnight in order to evaluate the solution's stability.

Tables 7-10 below detail observations of each trial wherein the clarifiers were added by wt-% into the formulation of Table 6. Observations included the viscosity of the solution after the addition of the clarifying agents, the stability of each formulation of 40° F. and at 120° F., and the appearance of the solution at room temperature. The x denoted in the Tables indicates no testing conducted as a result of the sample already separating.

TABLE 7

| | | | | | | |
|---|---|---|---|---|---|---|
| SXS | 3% | 4% | 5% | 10% | 12% | 14% |
| Viscosity | x | 427.2 | 437.6 | 409.6 | 432 | 448.8 |
| #2, | | | | | | |
| 50 rpm | | | | | | |
| Appear- | phase | clear | clear | clear | clear | clear |
| ance | separated | | | | | |
| @ RT | layers | | | | | |
| 40° F. | x | x | clear | clear | clear | hazy |
| stability | | | | | | |
| 120° F. | x | expected | separated | separated | clear | clear |
| stability | | to | layers | layers | | |
| | | separated | | | | |
| | | into | | | | |
| | | layers | | | | |
| | | given the | | | | |
| | | 5% | | | | |
| | | separated | | | | |
| | | into | | | | |
| | | layers | | | | |

TABLE 8

| | | | | | | |
|---|---|---|---|---|---|---|
| PG | 1% | 3% | 4% | 5% | 6% | 10% |
| Viscosity | x | x | x | 321.6 | 286.4 | 240 |
| #2, | | | | | | |
| 50 rpm | | | | | | |
| Appear- | phase | phase | phase | clear | clear | clear |
| ance | separated | separated | separated | | | |
| @ RT | layers | layers | layers | | | |
| 40° F. | x | x | x | clear | clear | clear |
| stability | | | | | | |
| 120° F. | x | x | x | clear | clear | clear |
| stability | | | | | | |

TABLE 9

| | | | | | | |
|---|---|---|---|---|---|---|
| SXS | 4% | 4% | 4% | 3% | 2% | 1% |
| PG | 3% | 2% | 4% | 4% | 4% | 4% |
| Viscosity | 322.4 | 364 | 316 | 327.2 | 331.2 | 299.2 |
| #2, | | | | | | |
| 50 rpm | | | | | | |
| Appear- | clear | clear | clear | clear | clear | clear |
| ance | | | | | | |
| @ RT | | | | | | |
| 40° F. | clear | clear | clear | clear | clear | clear |
| stability | | | | | | |
| 120° F. | clear | phase | clear | clear | phase | phase |
| stability | | separated | | | separated | separated |
| | | layers | | | layers | layers |

TABLE 10

| | | | |
|---|---|---|---|
| HG | 4% | | |
| SOS | | 3% | 4% |
| Viscosity | x | x | x |
| #2, | | | |
| 50 rpm | | | |
| Appear- | phase | phase | phase |
| ance | separated | separated | separated |
| @ RT | layers | layers | layers |
| 40° F. | x | x | x |
| stability | | | |
| 120° F. | x | x | x |
| stability | | | |

The results from Tables 7 indicates that 12% of Sodium Xylene Sulfonate when added to the solution of Table 6 creates a clear, stable, one phase and most economical formulation of each of the clarifying agents tested. Additionally, this clarifying agent resulted in a higher viscosity than the other clarifying agents when added to the solution of Table 6.

Tables 8 demonstrates that 5%, 6% and 10% of Propylene Glycol result in a clear, stable and one phase solution.

Table 9 demonstrates that a combination of Sodium Xylene Sulfonate and Propylene Glycol also results in a clear, one phase, stable solution.

Table 10 indicates that the use of Hexylene Glycol or Sodium Octyl Sulfonate did not yield a stable, one phase or clear solution. Indeed, the solutions were separated into layers and were not measured as a result of the separation as viscosity measurements are only reliable in stable, one phase solutions.

Critically, none of these solutions yielded a higher desired viscosity measurement of 600 to 800 cps. Thus, the clarifying agents cannot be said to have beneficial effect on viscosity.

### Example 5

To further evaluate viscosity of the formula a series of polymers (rheology modifiers) were tested with the solution described in Table 6.

The solution of Table 6 was tested again in 500 gram samples in beakers with different polymers in order to ascertain which rheology modifiers impacts viscosity. Additionally, each trial was also evaluated to see which rheology modifier yielded a solution with a clear appearance, a solution in one phase, any precipitation formation, and what the viscosity of the solution is.

A series of beakers filled with the solution from Table 6 at room temperature. Each beaker had varying amounts of rheology modifiers added to each of the beakers, each <10 wt-% with about 0.5-5 wt-% of each rheology modifier. Each beaker was then mixed on a bench top mixer at about ≤1000 rpm for about ≤1 hour and observed over the course of 24 hours at room temperature.

The polymers tested with the formula are as follows:
Acusol 820—Dow: HASE Associative anionic acrylic hydrophobically modified alkali swellable emulsion 1
Acusol 823—Dow: HASE-Associative anionic acrylic hydrophobically modified alkali swellable emulsion 2
Acusol 830—Dow ASE—Alkali swellable acrylic polymer 1
Acusol 805S—Dow HASE-hydrophobically-modified acrylic based alkali swellable emulsion 3
Acusol 801A—Dow HASE-hydrophobically-modified acrylic based alkali swellable emulsion 4
Acusol 810A—Dow ASE—Alkali Soluble acrylic polymer emulsion 1
Acusol 880—Dow Hydrophobically modified ethylene oxide urethane thickener 1
Rheolsolve T633—Arkema Acrylic copolymer 1
Rheosolve T635—Arkema Acrylic copolymer 2
Rheosolve T638—Arkema Acrylic copolymer 3
Rheosolve T700S—Arkema Acrylic copolymer 4
Flogel DE 35 HA—SNF ASE Alkali swellable emulsion polymer 2
Flogel DE 42 HA—SNF HASE-Hydrophobically modified alkali swellable emulsion polymer 5
Antil 141—Evonik—Polyethoxypropylene glycol dioleate
Antil 171—Evonik Polyol fatty acid ester
Rheovis AT 120—BASF HASE hydrophobically-modified acrylic based alkali swellable emulsion 6

Table 11 below details observations of each trial including the viscosity of the solution after the addition of the clarifying agents (based on wt-% added to the formula of Table 6), the stability of each formulation of 40° F. and at 120° F., and the appearance of the solution at room temperature.

TABLE 11

| | % | % | % | | Approx. | |
|---|---|---|---|---|---|---|
| Rheology Modifier | PG | SXS | Thickener | Comments | Viscosity | Appearance |
| Associative anionic | 3 | 4 | 0.5 | | ~300 | hazy |
| acrylic | | | | | | |
| hydrophobically | | | | | | |
| modified alkali | | | | | | |
| swellable emulsion 1 | | | | | | |
| Associative anionic | 3 | 4 | 0.5 | Different | ~300 | hazy |
| acrylic | | | | mix order | | |
| hydrophobically | | | | from above | | |
| modified alkali | | | | | | |
| swellable emulsion 1 | | | | | | |
| Associative anionic | 3 | 4 | 1 | | 417.6 | white, LAS |
| acrylic | | | | | | whipped up |
| hydrophobically | | | | | | |
| modified alkali | | | | | | |
| swellable emulsion 1 | | | | | | |
| Associative anionic | 3 | 4 | 1 | Different | 416.8 | clear - flakes |
| acrylic | | | | mix order | | turned |
| hydrophobically | | | | from above | | cloudy when |
| modified alkali | | | | | | pH adjusted |
| swellable emulsion 1 | | | | | | up |
| Associative anionic | 3 | 4 | 1 | Different | 352 | hazy |
| acrylic | | | | mix order | | |
| hydrophobically | | | | from above | | |
| modified alkali | | | | | | |
| swellable emulsion 1 | | | | | | |
| Associative anionic | 3 | 4 | 5 | | 475 | flakes |
| acrylic | | | | | | |
| hydrophobically | | | | | | |
| modified alkali | | | | | | |
| swellable emulsion 1 | | | | | | |
| Associative anionic | 0 | 12 | 2.5 | hazy | 458 | very thick |
| acrylic | | | | | | hazy |
| hydrophobically | | | | | | |
| modified alkali | | | | | | |
| swellable emulsion 1 | | | | | | |
| Associative anionic | 0 | 12 | 2 | hazy | 468 | |
| acrylic | | | | polymer on | | |
| hydrophobically | | | | bottom of | | |
| modified alkali | | | | beaker | | |
| swellable emulsion 2 | | | | | | |
| Hydrophobically- | 0 | 12 | 2 | phase | | |
| modified acrylic | | | | separated | | |
| based alkali swellable | | | | | | |
| emulsion 3 | | | | | | |
| Acrylic copolymer 1 | 0 | 12 | 2 | hazy | 452 | |
| Acrylic copolymer 4 | 0 | 12 | 2 | hazy | 446 | |
| | | | | polymer on | | |
| | | | | bottom of | | |
| | | | | beaker | | |
| (ASE) Alkali- | 0 | 12 | 2 | hazy | 626 | |
| swellable emulsion | | | | | | |
| polymer 2 | | | | | | |
| polyethoxypropylene | 0 | 12 | 2 | | 430 | |
| glycol dioleate | | | | | | |

The results indicated that each of the rheology modifiers tested, only one of the trials resulted in a desired above 600 cps measurement of viscosity. However, the Alkali-swellable acrylic polymer 2 addition to the formula of Table 6 did not result in a clear solution. Instead, the solution was found to have a hazy appearance.

In addition to the testing outlined in Table 11, additional trials were run with xanthan and diutan gum following the same procedure outlined above. Additionally, both were tested for stability in a refrigerator at 40° F. and in an oven at 120° F. Each beaker was placed in the refrigerator and then oven overnight and monitored for stability over the course of four weeks. Both xanthan gum and diutan gum when added to the solution of Table 6 were found to create cloudiness or phase separation. This indicates that these polymers also did not beneficially help viscosity while also maintaining a stable, clear and one phase composition.

This indicates that the evaluated rheological modifiers did not fundamentally affect the viscosity while also creating a clear, one phase solution. These results show that the evaluated rheology modifiers would only be suitable as part of an optional additional functional ingredient.

### Example 6

The solution of Table 6 was tested with different salts in order to ascertain which salts impacts viscosity. Additionally, each trial was also evaluated to see which salt yielded a solution with a clear appearance, a solution in one phase, any precipitation formation, and what the viscosity of the solution is.

A series of beakers filled with the solution from Table 6 at 500 gram sample sizes at room temperature. Each beaker had an aliquot of salt added to each of the beakers at either 0.5 wt-% or 1 wt-% salt addition in series added to the same beaker. The samples were stirred for about >5 minutes and then viscosity was measured and recorded before the samples were placed back on the mixer and next aliquot of salt was added. The same procedure was repeated until peak was reached on salt curve (viscosity vs % salt by weight graph).

Each beaker was then mixed on a bench top mixer at rpm about ≤1000 rpm for five minutes and subsequently measured with a viscometer to determine the viscosity of the solution. This process was repeated with another aliquot of salt added to the same beaker before mixing again for five minutes and once again measuring the viscosity of the solution with a viscometer.

The salts tested with the solution of Table 6 were NaCl and Na₂SO₄. Table 12 below details observations of the viscosity and appearance of each trial run with the different salts and varying pH levels. The table shows percent salt by weight. The table shows the amount of salt for the formula that resulted in the desired viscosity from the prior salt curve experiments.

TABLE 12

| | | | | | Salt | | |
|---|---|---|---|---|---|---|---|
| % | % | | % | | Addition | Approx | |
| PG | SXS | Salt | Salt | pH | Position | Viscosity | Appearance |
| 3 | 4 | NaCl | 3 | | end | 800 | hazy |
| 3 | 4 | Na₂SO₄ | curve | | end | thin | did not |
| | | | | | | | dissolve |
| 3 | 4 | NaCl | 3 | | beginning | 1400 | hazy |
| 3 | 4 | NaCl | 3 | 7.68 | beginning | 888 | separated |
| | | | | | | | into layers |
| 3 | 4 | NaCl | 3 | 8 + | beginning | 684 | hazy |
| | | | | 0.52 g | | | |
| | | | | NaOH | | | |
| | | | | 8.18 | | | |
| 3 | 4 | NaCl | 3 | 8.5 + | beginning | 644 | hazy |
| | | | | 0.46 g | | | |
| | | | | NaOH | | | |
| 3 | 4 | NaCl | 2 | 7.63 | beginning | 320 | separated |
| | | | | | | | into layers |
| 3 | 4 | NaCl | 2 | 8 + | beginning | 312 | separated |
| | | | | 0.41 g | | | into layers |
| | | | | NaOH | | | |
| | | | | 8.12 | | | |
| 3 | 4 | NaCl | 2 | 8.5 + | beginning | 302 | separated |
| | | | | 0.44 g | | | into layers |
| | | | | NaOH | | | |
| | | | | 8.55 | | | |
| 3 | 4 | NaCl | 1 | 7.96 | beginning | 238.4 | separated |
| | | | | | | | into layers |
| 3 | 4 | NaCl | 1 | 8.5 + | beginning | 252 | separated |
| | | | | 0.89 g | | | into layers |
| | | | | NaOH | | | |
| | | | | 8.84 | | | |
| 3 | 4 | NaCl | 1 | 9 + | beginning | 254 | separated |
| | | | | 0.31 g | | | into layers |
| | | | | NaOH | | | |
| | | | | 9.33 | | | |
| 4 | 3 | NaCl | 3 | 9.75 | beginning | 728 | hazy |
| 4 | 4 | NaCl | 3 | 8.05 | beginning | 584 | separated |
| | | | | | | | into layers |
| 5 | 0 | NaCl | 3 | | beginning | 1600 | hazy |
| 5 | 0 | NaCl | 3 | 7.4 | beginning | 1332 | hazy |
| 5 | 0 | NaCl | 2 | 8.6 | beginning | 404 | separated |
| | | | | | | | into layers |
| 6 | 0 | NaCl | 2.5 | 7.33 | beginning | 736 | hazy |
| 8 | 0 | NaCl | 2.5 | 8.22 | beginning | 240 | separated |
| | | | | | | | into layers |

The results of the testing from Table 12 indicated that while some of the solutions prepared with NaCl did result in a viscosity of 600 cps to 800 cps. FIG. 6 also demonstrates that as the amount of salts (NaCl and Na₂SO₄) are increased in the solution, the level of viscosity increased, especially in the case of NaCl. However, as indicated in Table 12, none of these solutions resulted into a clear, stable and one phase solution. Therefore, none of the salts tested in Table 12 resulted in a higher viscosity above 600 cps and a clear, stable one phase solution.

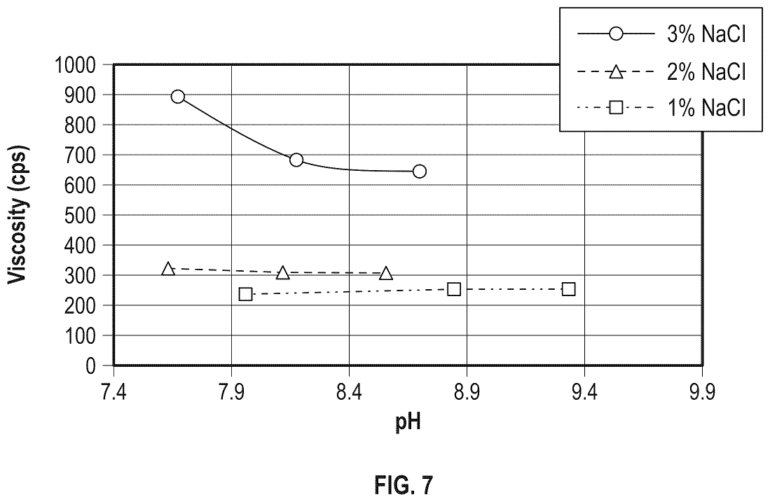

FIG. 7 also demonstrates that when the pH is altered as demonstrated in Table 12, the viscosity of the solution varies. When there is 3% of NaCl present in the solution, the viscosity decreases drastically. When the solution has a 2% of NaCl in the solution, there is a slight decrease. Finally, if the solution has 1% of NaCl, the viscosity slightly increases.

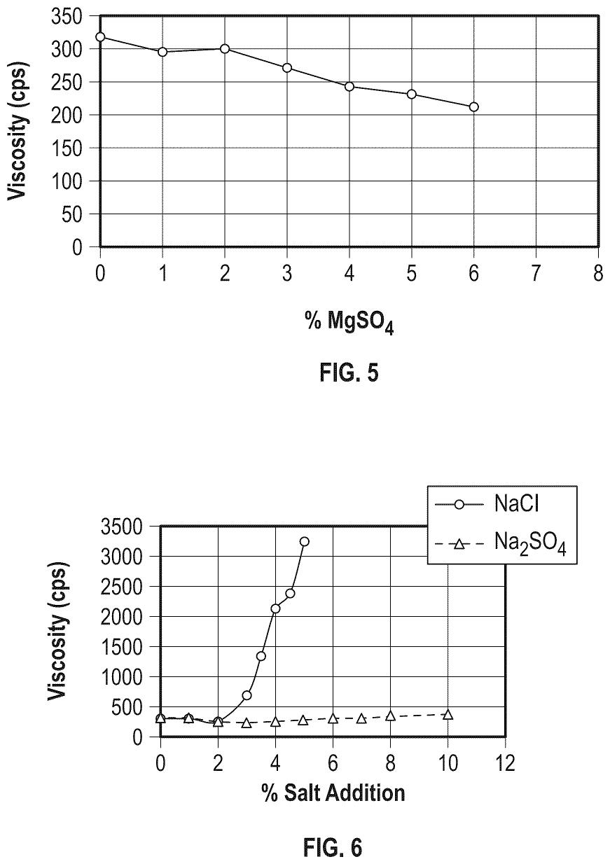

Additionally, FIG. 5 demonstrates that additional testing conducted with MgSO₄ with the solution of Table 6 did not show better results. The same procedure was followed as mentioned above. The results in FIG. 5 demonstrates that the viscosity of the solution decreased as the weight percentage of MgSO₄ increased in the solution. Thus, additional salts such as MgSO₄ do not beneficially increase the viscosity of the solution.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized, and structural changes may be made without departing from the scope of the present disclosure.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A concentrated liquid composition comprising:
at least about 40% active surfactants in the composition comprising:
(i) an amine oxide surfactant,
(ii) an anionic sulfonate surfactant, and
(iii) an alkoxylated nonionic surfactant,
wherein the actives basis ratio of the anionic sulfonate surfactant to the amine oxide surfactant is about 7:1 to about 10:1; and
wherein the concentrated liquid composition has less than about 1 ppm 1,4-dioxane.

2. The composition of claim 1, wherein the composition has between about 40-50% active surfactants in the composition.

3. The composition of claim 1, wherein the amine oxide surfactant is a C10-C20 straight or branched chain, saturated or unsaturated alkyl di(C1-C7) amine oxide.

4. The composition of claim 1, wherein the anionic sulfonate surfactant comprises an alpha-olefin sulfonate (AOS) and wherein the ratio of the AOS to amine oxide on an actives basis is from about 3:1 to about 5:1.

5. The composition of claim 1, wherein the anionic sulfonate surfactant comprises an alkyl benzene sulfonate surfactant (LAS), and optionally wherein the anionic sulfonate surfactant comprises an alkyl benzene sulfonate surfactant (LAS) and an alpha-olefin sulfonate (AOS) and wherein the ratio of the sulfonate surfactants to the amine oxide on an actives basis is from about 7:1 to about 10:1.

6. The composition of claim 1, wherein the alkoxylated nonionic surfactant comprises a polyoxypropylene-polyoxyethylene block copolymer surfactant having the structure R—O—(PO)y(EO)x(PO)z where R is an alkyl group, x=9-22, y=1-4 and z=10-20, or R—O-(EO)x(PO)y(EO)x where R is an alkyl group, x=10-130 and y=15-70.

7. The composition of claim 1, wherein the alkoxylated nonionic surfactant comprises an alcohol alkoxylate having the structure R—O—(CH₂CH₂O)n-H wherein R is a (C1-C12) alkyl group, and n=1-100, or an alcohols C6-C10, ethoxylated, propoxylated.

8. The composition of claim 1, wherein the anionic sulfonate surfactant comprises an alpha-olefin sulfonate (AOS) and alkyl benzene sulfonate surfactant (LAS).

9. The composition of claim 1, wherein the amine oxide surfactant comprises from about 5 wt-% to about 20 wt-% of the composition, the anionic sulfonate surfactant comprises from about 25 wt-% to about 80 wt-% of the composition, and the alkoxylated nonionic surfactant comprises from about 5 wt-% to about 20 wt-% of the composition.

10. The composition of claim 9, wherein the anionic sulfonate surfactant comprises from about 10 wt-% to about 60 wt-% of an alpha-olefin sulfonate (AOS) and from about 5 wt-% to about 20 wt-% of an alkyl benzene sulfonate surfactant (LAS).

11. The composition of claim 1, further comprising propylene glycol and/or an alkyl polyglycoside.

12. The composition of claim 1, wherein the concentrated liquid composition has a viscosity between about 500 cPs to about 1000 cPs when measured with a Brookfield RV Viscometer at 25° C. with Spindle #2 or #3 at 50 rpm, and wherein the concentrated liquid composition achieves the liquid viscosity without the use of salts, gums, polysaccharides, clays and/or polymers.

13. The composition of claim 1, wherein the concentrated liquid composition has a measured cylinder foam between about 200 to about 250 as measured by a Cylinder Foam Test, or wherein the foam profile as measured in a cylinder foam test is substantially equivalent to a non-concentrated liquid composition.

14. The composition of claim 1, wherein the composition is free of sodium lauryl ether sulfate (SLES).

15. A method of using a concentrated foam-controlled dishwashing composition comprising:
contacting a ware surface within a recirculating sink or other containment with a use solution of the composition according to claim 1; and
cleaning the ware.

16. The method of claim 15, further comprising an initial step of dispensing the concentrated liquid composition.

17. The method of claim 15, wherein the viscosity of the concentrated liquid composition is increased by increasing the actives ratio of the anionic sulfonate surfactant to the amine oxide surfactant up to about 10:1 to slow the dispensing rate.

18. The method of claim 15, further comprising generating the use solution with the concentrated liquid composition by adding into the recirculating sink between about 0.04% to about 0.2% by weight of the concentrated liquid composition with the total volume of water in the recirculating sink.

19. The method of claim 15, wherein the recirculating sink is an open washing device, or wherein the other containment is a sink or vessel for washing ware.
